(19) United States
(12) Patent Application Publication
(10) Pub. No.: US 2012/0309929 A1
(43) Pub. Date: Dec. 6, 2012

(54) PROCESS AND APPARATUS FOR PRODUCING ALIPHATIC POLYESTER

(76) Inventors: Naoki Hayashi, Tokyo (JP); Takahiro Watanabe, Tokyo (JP); Yoshinori Suzuki, Tokyo (JP); Kazuyuki Yamane, Tokyo (JP)

(21) Appl. No.: 13/488,829

(22) Filed: Jun. 5, 2012

(30) Foreign Application Priority Data
Jun. 6, 2011 (JP) 126634/2011(PAT.)

(51) Int. Cl. C08G 63/78; B01J 19/00; C08G 63/08

(52) U.S. Cl. 528/354; 422/131

(57) ABSTRACT

A process for producing an aliphatic polyester includes the steps of: heating a cyclic ester at a melting point or higher to transform the cyclic ester into molten state and convert a moisture contained in the cyclic ester into free carboxylic acid; measuring an amount of the free carboxylic acid in the molten cyclic ester; feeding a proton-source compound in an amount determined based on the measured amount of the free carboxylic acid into the molten cyclic ester; and subjecting the cyclic ester to ring-opening polymerization. The process provides an aliphatic polyester with a desired molecular weight which can be set easily and accurately. An apparatus for the process is also provided.

### TECHNICAL FIELD

The present invention relates to a process and an apparatus for producing aliphatic polyester by ring-opening polymerization of a cyclic ester,

### BACKGROUND ART

Aliphatic polyesters, such as polyglycolic acid and polylactic acid, can be decomposed by microorganisms or enzymes present in nature, such as soil or sea water, so that they are noted as biodegradable polymer materials giving little load to the environment.

Among the aliphatic polyesters, polyglycolic acid is excellent in gas-barrier properties, such as oxygen gas-barrier property, carbon dioxide gas-barrier property and water vapor-barrier property, and also excellent in heat resistance and mechanical properties. Therefore, various applications or new uses of polyglycolic acid by itself or as a composite with another resin, are under development in the fields of packaging materials, etc.

In order to effectively synthesize an aliphatic polyester of a high molecular weight, there has been adopted ring-opening polymerization of a bimolecular cyclic ester of an α-hydroxycarboxylic acid. For example, by ring-opening polymerization of glycolide that is a bimolecular cyclic ester of glycolic acid, polyglycolic acid is obtained. By ring-opening polymerization of lactide that is a bimolecular cyclic ester of lactic acid, polylactic acid is obtained.

In the ring-opening polymerization of such a cyclic ester, water and alcohols are used as a molecular weight modifier to control the molecular weight of an aliphatic polyester. On the other hand, it is pointed out that if impurities such as moisture and a free carboxylic acid are contained in the cyclic ester, they will adversely affect polymerization reaction, so that it becomes difficult to achieve the targeting of a molecular weight of the product aliphatic polyester at a desired value even if the same polymerization conditions are used (for example, Patent Document 1).

For this reason, there has been proposed a process including using a high-purity cyclic ester from which moisture is removed as much as possible by drying, quantitatively measuring a free carboxylic acid contained in the cyclic ester, determining the amount of a hydroxy compound to be added to a polymerization system based on the amount of the free carboxylic acid, and charging the hydroxy compound into the system to perform ring-opening polymerization to thereby obtain an aliphatic polyester having a desired molecular weight (for example, Patent Document 1).

However, water (=moisture) is the most universal compound present in nature, and there is a limit in eliminating moisture as an impurity. Accordingly, there has been made a detailed study on a method of controlling the molecular weight in the situation where moisture is present in a cyclic ester, and it has been found that the molecular weight of an aliphatic polyester to be produced is controllable by controlling the total concentration of protons in a reaction system including moisture and a free carboxylic acid in a cyclic ester because all the proton-source compounds in the polymerization system including not only the free carboxylic acid but water act as an initiator or/and a molecular weight modifier (for example, Patent Document 2).

Accordingly, there has been proposed a process including quantitatively measuring a free carboxylic acid and moisture, respectively, contained in a cyclic ester to derive a proton concentration in the cyclic ester, determining the amount of a proton-source compound to be added to a polymerization system based on the proton concentration, and charging the proton-source compound to control the total concentration of protons in the polymerization system before performing ring-opening polymerization, thereby obtaining polyglycolic acid having a desired molecular weight (for example, Patent Documents 2 and 3).

### PRIOR ART DOCUMENTS

### Patent Documents

Patent documents 1: JP1995-233246A

Patent documents 2: W02004/033527A

Patent documents 3: W02005/044894A

### SUMMARY OF THE INVENTION

Incidentally, in actual commercial production, it is required to quickly obtain the results of analysis and quickly feed them back to production conditions. In the proposed process described above, since moisture and a free carboxylic acid are analyzed separately in order to estimate the concentration of protons in a cyclic ester, the man-hour therefore will increase. As a result, the analysis has taken a substantial time, thus generating time lag in the feedback of the results to production conditions.

Further, it is important to accurately quantitatively measure both a free carboxylic acid and moisture in the process proposed in Patent Documents 2 and 3 as described above. Technical progress so far achieved, has enabled quantitative measurement of a free carboxylic acid in a cyclic ester with high accuracy. On the other hand, since moisture may vaporize during handling or may react with a cyclic ester, it is difficult to quantitatively measure the moisture in a cyclic ester with high accuracy under the present circumstances. For this reason, it has been difficult to estimate the total concentration of protons (moisture, free carboxylic acid) in a cyclic ester for controlling the molecular weight immediately before initiation of polymerization reaction with high accuracy according to the proposed methods as described above. For this reason, above mentioned methods had a problem in the accuracy of targeting so that the molecular weight varied even if the same polymerization conditions were used.

As a result of intensive and extensive studies, the present inventors have found that the problems in speed-up of analysis and higher accuracy of the quantitative measurement of the concentration of protons in a cyclic ester can be solved inclusively by reacting moisture in a cyclic ester with the cyclic ester to form a free carboxylic acid and quantitatively measuring, collectively, a free carboxylic acid which has been contained in the cyclic ester and a free carboxylic acid which is produced by the reaction of moisture with the cyclic ester, and thus have completed the present invention. According to the present invention, the necessity of moisture measurement is eliminated, and the evaluation items are unified into the measurement of a free carboxylic acid to achieve the speed-up of analysis. Therefore, feedback to setting of production conditions is performed in a short time, allowing efficient production to be performed. Further, since a free carboxylic acid is stably present in a cyclic ester, the free carboxylic acid can be measured quantitatively with high accuracy as described above.

The present invention has been made in consideration of such circumstances, and an object of the present invention is to provide a process and an apparatus for producing an aliphatic polyester whereby a desired molecular weight is easily and accurately obtained by achieving the speed-up of analysis and estimating the concentration of protons in a cyclic ester for controlling a molecular weight with high accuracy.

Thus, according to the present invention, there is provided a process for producing an aliphatic polyester, including the steps of: heating a cyclic ester at a melting point or higher to transform the cyclic ester into molten state and convert a moisture contained in the cyclic ester into a free carboxylic acid; measuring an amount of the free carboxylic acid in the molten cyclic ester; feeding a proton-source compound in an amount determined based on the measured amount of the free carboxylic acid into the molten cyclic ester; and subjecting the cyclic ester to ring-opening polymerization.

In the process the concentration of protons in the molten cyclic ester immediately before polymerization can be estimated accurately by setting the temperature of the cyclic ester at the melting point or higher to allow the moisture to chemically react with the cyclic ester and be converted into a free carboxylic acid corresponding to the cyclic ester. The resulting free carboxylic acid is quantitatively measured together with a free carboxylic acid inevitably contained during the production of the cyclic ester. Thus, an aliphatic polyester having a desired molecular weight can be obtained by feeding an amount of a proton-source compound based on the concentration of the carboxylic acid (=protons) in the cyclic ester so as to control the total concentration of protons in the polymerization system at a value corresponding to a desired target molecular weight of the product aliphatic polyester before subjecting the cyclic ester to ring-opening polymerization.

The present invention provides a process and an apparatus for producing an aliphatic polyester of a desired molecular weight which can be set easily and accurately.

### BRIEF DESCRIPTION OF THE DRAWINGS

FIG. 1 shows a block diagram of an aliphatic polyester-production apparatus according to an embodiment of the present invention.

FIG. 2 is a graph showing a correlation between total proton concentration in the polymerization system and melt viscosity as measured at a shear rate 122 sec⁻¹ and a temperature of 240° C. of product aliphatic polyesters polymerized according to a process for producing polyglycolic acid by ring-opening polymerization of glycolide according to the present invention.

FIG. 3 is a graph showing increase-with time of free carboxylic acid in the glycolide system after being admixed with water and held at temperatures of 100° C., 120° C. and 140° C.

FIG. 4 is a graph showing plot of temperature-dependence of increase in equivalent number of free carboxylic acid in molten glycolide in atmospheres of Air and N₂.

FIG. 5 is a graph showing a calibration curve for the UV-VIS method as a method for quantitative measurement of free carboxylic acid.

### DETAILED DESCRIPTION

Some preferred embodiments of the present invention are described below, principally with reference to glycolide (melting point 85° C.) as a preferred example of cyclic ester.

### (Step of Heating a Cyclic Ester at a Melting Point or Higher)

A cyclic ester is weighed and charged into a melting tank, and the temperature of the melting tank is then set at the melting point of the cyclic ester or higher. The temperature of the melting tank is preferably set in the range of 85° C. to 160° C., more preferably in the range of 90° C. to 120° C. If the temperature is lower than 85° C., the melting of the cyclic ester will not proceed, and if the temperature is higher than 160° C., the cyclic ester is liable to decompose (refer to the paragraph of “Study of the duration of maintaining molten glycolide” described below). The heating method includes, but is not limited to, a method in which the melting tank is immersed in a temperature-controllable oil bath, a method in which a jacket is provided on the outside of the melting tank and a heat-exchange medium such as warm water, steam, and heat transfer oil is circulated therethrough, a method in which the melting tank is heated with an electric heater from the outside thereof, and a method in which the melting tank is placed into a circulating hot air oven.

### (Step of Converting a Moisture Contained in the Cyclic Ester Into Free Carboxylic Acid)

After the temperature of the melting tank is set at a prescribed temperature higher than the melting point thereof, the cyclic ester is maintained at the temperature for a predetermined time or more in order to convert the moisture contained in the cyclic ester into a free carboxylic acid. Thereby, the moisture causes hydrolysis of the cyclic ester in an equal mole and is converted into an equal mole of the corresponding free carboxylic acid. The temperature higher than the melting point is preferably maintained for 1 hour or more, more preferably for 2 hours or more, most preferably for 3 hours or more. If the duration of maintaining the cyclic ester at the temperature is less than 1 hour, the proportion of moisture which reacts with the cyclic ester to convert it into a free carboxylic acid is decreased, so that the concentration of protons in the cyclic ester estimated from the results of quantitative measurement of the free carboxylic acid is liable to be inaccurate.

As a result, an appropriate amount of proton-source compounds is not fed in the subsequent step, so that an aliphatic polyester having a desired molecular weight cannot be obtained (refer to the paragraph of “Study of the duration of maintaining molten glycolide” described below). Further, the purpose of this step is to convert moisture in a cyclic ester into a free carboxylic acid in order to accurately estimate the concentration of protons in the cyclic ester. The place for converting the moisture into the free carboxylic acid is therefore not necessarily limited to the melting tank. It is thus possible to apply a method of dispensing or sampling a cyclic ester immediately after setting its temperature at the melting point thereof or higher, separately holding the dispensed sample at the inciting point thereof or higher to convert it into a free carboxylic acid, and measuring the concentration of the free carboxylic acid.

### (Step of Measuring an Amount of the Free Carboxylic Acid in Cyclic Ester in Molten State)

Water contained in a cyclic ester is converted into a free carboxylic acid, the cyclic ester is then dispensed, and the concentration of the free carboxylic acid in the cyclic ester is quantitatively measured. A neutralization titration method, a gas chromatography method (a GC method), and UV-VIS (Ultraviolet Visible Absorption) spectrometry are preferably used as a quantitative measurement method. The quantitative measurement method is not limited to these methods, however, and any method which allows a very small amount of free carboxylic acid contained in a dispensed cyclic ester to be quantitatively measured with high accuracy will be suitably employed.

The neutralization titration method is a method of gradually dropping a basic neutralization liquid being dropped to determine the point of neutralization, while checking the acidity of the test liquid in which cyclic ester was dissolved. The solvent for the test liquid may suitably be acetone, methanol, benzyl alcohol, DMSO DMF and DMAc, for example and the neutralization liquid may suitably be obtained by dissolving sodium hydroxide, potassium hydrate, sodium methoxide, sodium ethoxide, sodium isopropoxide, potassium methoxide, potassium ethoxide, potassium isopropoxide, triethyl amine, diisopropylamine, and diazabicycloundecen within acetone, methanol, ethanol, HFIP, DMSO, or a mixture of those. The determination of the point of neutralization may be performed by using color reagents, such as phenolphthalein, phenol red, butyl thymol blue (BTB), butyl thymol blue sodium (BTBNa), methyl red, methyl orange to detect discoloration, and using a pH meter to detect pH change.

The GC (Gas Chromatography) method is a method of subjecting a free carboxylic acid in a cyclic ester to methyl esterification with a methylation agent such as diazornethane, and quantitatively measuring the methyl-esterified material by GC, wherein the methylation agent and GC measurement conditions may be suitably selected.

The UV-VIS spectrometry is a method of dissolving a cyclic ester in a solvent illustrated in the above-described neutralization titration method, adding a color reagent illustrated in the above-described neutralization titration method to prepare a test liquid, measuring a UV-VIS spectrum of the test liquid, and determining the concentration of a free carboxylic acid from a calibration curve prepared beforehand based on the peak waveform of the spectrum. For example, when the UV-VIS spectrum measurement is performed in the case where BTB is used as a color reagent, the peaks will be observed at 412 nm and 636 nm. Since the proportion of these peaks changes with the concentration of the free carboxylic acid in a sample, the concentration of the free carboxylic acid in the sample can be determined from the proportion of these peaks obtained by the UV-VIS measurement. Since this technique allows an instantaneous measurement unlike the two other methods described above, it is preferably used from the point of view of increasing the rapidity of analysis.

The concentration of protons contained in a cyclic ester is calculated based on the molecular weight of the cyclic ester, the molecular weight and content of a free carboxylic acid, and the number of hydroxy groups in the free carboxylic acid (generally one), in terms of mol % on the basis of the total amount of the cyclic ester and impurities. The concentration of protons contained in the cyclic ester is preferably 0.5 mol % or less, more preferably 0.4 mol % or less, most preferably 0.35 mol % or less. If the proton concentration based on the free carboxylic acid is too high, accurate control of the melt viscosity, molecular weight and the like by the addition of a proton-source compound in the subsequent step will be difficult.

(Step of Feeding Proton-Source Compound in an Amount Determined Based on the Measured Amount of the Free Carboxylic Acid into the Molten Cyclic Ester)

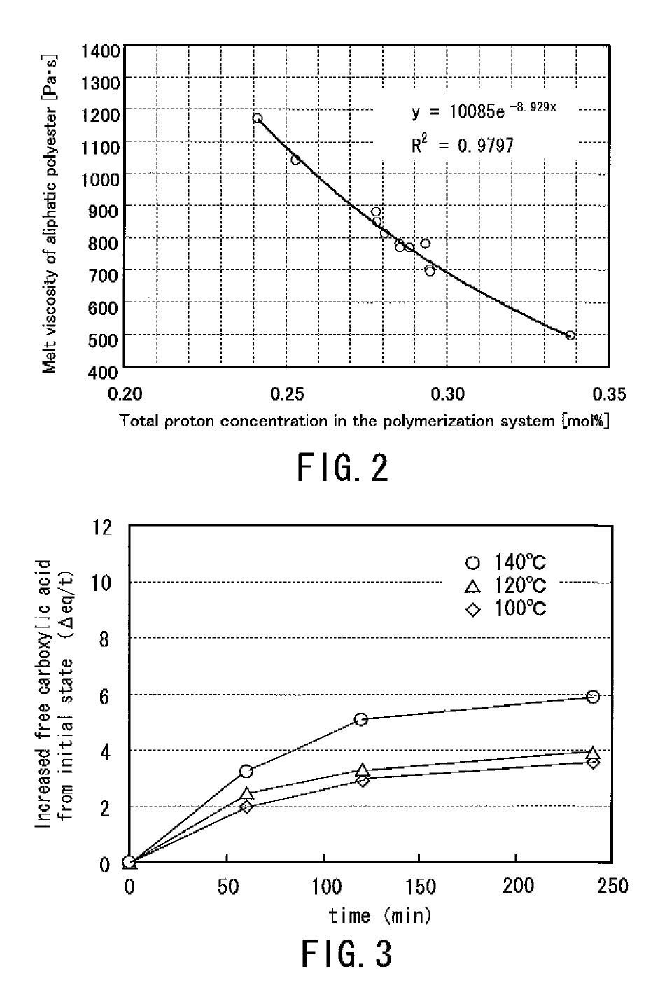

The relationship between the total concentration of protons in the polymerization system and the molecular weight of an aliphatic polyester polymerized will be described. The graph in FIG. 2 shows the results of the polymerization performed by the present inventors based on the present invention and the results of the measurement of the melt viscosity (y) at a temperature of 240° C. and a shear rate of 122 sec⁻¹ of resultant polyglycolic acid (aliphatic polyester) versus the total concentration of protons (x) in the glycolide (cyclic ester) polymerization system.

Here, the melt viscosity of an aliphatic polyester on the ordinate takes a value corresponding to the molecular weight of the aliphatic polyester. Accordingly, controlling the melt viscosity of the aliphatic polyester corresponds to controlling the molecular weight thereof. As shown in this graph, in the ring-opening polymerization step of the cyclic ester, a certain correlation has been found between the total concentration of protons in the polymerization system and the melt viscosity of the aliphatic polyester produced. From the results of the regression analysis of this relationship, relational expressions of a linear model, a log-log model, and a semi-log model can be respectively obtained. Among these models, a relational expression of a semi-log model represented by y=a×b^{x} has been found to show a high multiple correlation coefficient R and a high multiple coefficient of determination R².

When a target melt viscosity (y) is substituted in this relational expression, the total concentration of protons (x) in the polymerization system corresponding to the melt viscosity will be calculated. Here, since the total concentration of protons in the polymerization system is a value obtained by adding up the concentration of protons in the cyclic ester and the concentration of protons based on the proton-source compound fed to the polymerization system, an aliphatic polyester having a target melt viscosity can be obtained by, calculating the difference between the total concentration of protons in the polymerization system and the concentration of protons in the cyclic ester and feeding the proton-source compound corresponding to the amount of the difference.

Examples of the proton-source compound may include moisture and hydroxyl compound. The hydroxyl compound may include lower and medium alcohols which are aliphatic alcohols having 1-5 carbon atoms, and higher alcohols which are aliphatic alcohols having 6 or more carbon atoms. These aliphatic alcohols can have a branched structure. Further, alicyclic alcohols, unsaturated alcohols, aromatic alcohols and polyols are also included. Further, it is also possible to use hydroxycarboxylic acids having a hydroxyl group and saccharides.

Among above described compound, it is preferred to use medium or higher alcohols having at least 3 carbon atoms such as propanol, 2-propanol, butanol, 2-butane-ol, t-butyl alcohol, octyl alcohol, dodecyl alcohol (lauryl alcohol) and myristyl alcohol; alicyclic alcohols such as cyclohexanol; dials such as ethylene glycol, butane diol and hexane diol; and trials such as glycerin, in view of the solubility in the monomer, reactivity (initiator efficiency), boiling point and commercial availability. These alcohols can be used in two or more species in combination.

The proton-source compound are not limited to the above-mentioned compounds, and other compounds can also be used suitably if they show a molecular weight-controlling functions as a proton-source compound in the aliphatic polyester as illustrated in FIG. 2. As mentioned above, the quantity of the proton-source compound fed into the aliphatic polyester is obtained as a value obtained by subtracting the proton concentration corresponding to the measured amount of the free carboxylic acid from the proton concentration corresponding to the desired viscosity (desired molecular weight) derived from FIG. 2.

### (Step of Subjecting Cyclic Ester to Ring-Opening Polymerization)

In order to produce an aliphatic polyester using a cyclic ester, it is preferred to adopt a method of heating and melting the cyclic ester in the presence of a catalyst to effect the cyclic ester in the molten state to ring-opening polymerization. This ring-opening polymerization process is performed by using a reaction vessel or a tubular, columnar or extruder-type reaction vessel in a batch or in a continuous manner. The ring-opening polymerization is conducted at a temperature within a range of generally 100 to 270° C., preferably 120 to 260° C.

Further, it is preferred to adopt a process of transferring a cyclic ester in a molten state to a polymerization apparatus equipped with a plurality of tubes (including those having both ends capable of opening and closing as preferable embodiments) and effecting the ring-opening polymerization in each tube placed in a hermetic state to precipitate the resultant polymer. It is also preferred to adopt a process of proceeding with ring-opening polymerization of a molten cyclic ester in a reaction vessel equipped with a stirrer, taking up the resultant polymer to once cool and solidify the polymer and then further continuing solid-phase polymerization below the melting point of the polymer. These processes may be performed either batchwise or in a continuous manner. When mass-producing, it is preferred to adopt the continuous manner (refer to the paragraph of “Example of a production apparatus” mentioned later).

Preferred cyclic esters used in the present invention may include cyclic diesters of α-hydroxycarboxylic acids and lactones. Examples of the α-hydroxycarboxylic acids providing the cyclic diesters may include: glycolic acid, L- and/or D-lactic acid, α-hydroxybutanoic acid, α-hydroxyisobutanoic acid, α-hydroxyvaleric acid, α-hydroxycaproic acid, α-hydroxy-isocaproic acid, α-hydroxyheptanoic acid, α-hydroxy-octanoic acid, α-hydroxydecanoic acid, α-hydroxymyristic acid, α-hydroxystearic acid, and alkyl-substituted products of these.

Examples of the lactones include β-propiolactone, β-butyrolactone, pivalolactone, γ-butyrolactone, δ-valerolactone, β-methyl-δ-valerolactone and ε-caprolactone. The cyclic etheresters may include dioxanone, for example.

A cyclic ester having an asymmetric carbon atom may be any of a D-isomer, an L-isomer and a racemic mixture of these. These cyclic esters may be used either singly or in any combination thereof. When two or more cyclic esters are used in combination, an arbitrary aliphatic copolyester can be obtained. The cyclic ester may be copolymerized with another comonomer. Examples of such another comonomer include cyclic monomers, such as trimethylene carbonate and 1,3-dioxolane.

Among the cyclic esters, glycolide, which is a cyclic diester of glycolic acid, L- and/or D-lactide, which is a cyclic diester of L- and/or D-lactic acid, and mixtures thereof are preferred, with glycolide being further preferred. Glycolide may be used alone. Further, it may also be used in combination with another cyclic monomer to produce a polyglycolic acid copolymer (copolyester). When the polyglycolic acid copolymer is produced, it is desirable that a proportion of glycolide copolymerized is preferably at least 60% by weight, more preferably at least 70% by weight, particularly preferably at least 80% by weight from the viewpoint of physical properties of the copolyester formed, such as crystalline properties, and gas-barrier properties. As preferable examples of the cyclic monomer copolymerized with glycolide, lactide, ε-caprolactone and trimethylene carbonate are raised.

Examples of the catalysts include metallic compounds such as oxides, halides, carboxylates and alkoxides of tin (Sn), titanium (Ti), aluminum (Al), antimony (Sb), germanium (Ge), zirconium (Zr) and zinc (Zn). More specifically, preferable examples thereof include tin compounds such as tin halides (for example, tin dichloride, tin tetrachloride, etc.) and organic tin carboxylates (for example, tin octanoates such as tin 2-ethylhexanoate); titanium compounds such as alkoxytitanium; aluminum compounds such as alkoxyaluminum; zirconium compounds such as zirconium acetylacetone; and antimony compounds such as antimony halides. No particular limitation is imposed on the catalyst so far as it may be used as a ring-opening polymerization catalyst for respective cyclic esters. The amount of the catalyst used may be in a small amount relative to the cyclic ester and is generally 0.1-300 ppm, preferably 1-100 ppm, more preferably 10-60 ppm, on a weight basis based on the cyclic ester.

### (Holding of Cyclic Ester in a Molten State)

Depending on the process for production of an aliphatic polyester, the cyclic ester may be held in a molten state for a long period of time after the cyclic ester has passed through the above-described “Step of measuring an amount of the free carboxylic acid in cyclic ester in molten state” before it is supplied to the “Step of subjecting cyclic ester to ring-opening polymerization”. The proton concentration is preferably kept at a fixed value during the holding of the molten state of the cyclic ester, and it is preferred to hold the cyclic ester in a molten state in a condition where the carboxylic acid concentration hardly changes. Specifically, it is preferred to hold the cyclic ester in a molten state in the range of 85° C. or higher and lower than 110° C., preferably in the range of 90° C. to 105° C. If the holding temperature is lower than 85° C., the cyclic ester in a molten state can be recrystallized, and if the holding temperature is 110° C. or higher, the concentration of the free carboxylic acid can be increased by the interaction with oxygen in a vapor phase (refer to the paragraph of “Influence of the holding temperature of molten glycolide” described below).

### (Example of Production Apparatus)

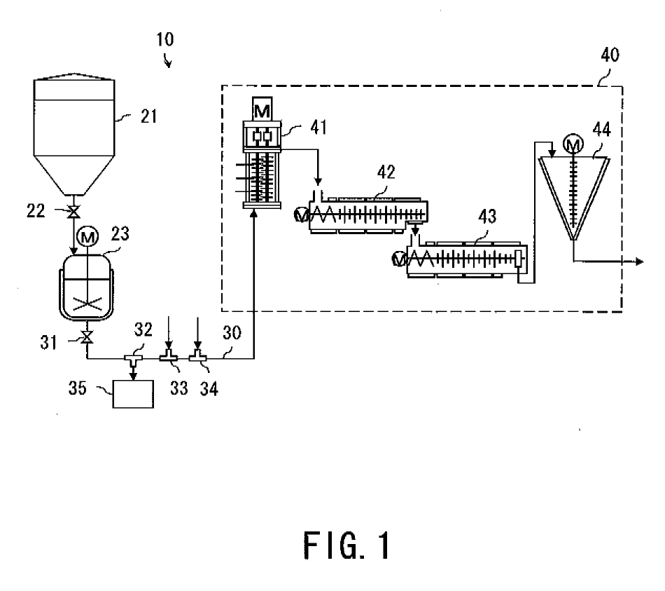

Hereafter, an example of the production apparatus is explained based on an accompanying drawing. As shown in FIG. 1, the aliphatic polyester production apparatus 10 (hereinafter, sometimes called apparatus 10) comprises, a melting tank 21 for heating the cyclic ester at a melting point or higher to transform the cyclic ester into molten state and convert the moisture contained in the cyclic ester into a free carboxylic acid; a dispensing part 32 for sampling the molten cyclic ester for quantitative measurement of the free carboxylic acid; a feed part 33 for feeding the proton-source compound in an amount determined based on the measured amount of the free carboxylic acid into the molten cyclic ester; and a polymerization section 40 for subjecting the cyclic ester to ring-opening polymerization.

A melting tank 21 is set at the temperature described in the above-described “Step of heating a cyclic ester at a melting point or higher” and maintained for the time period as described in the above-described “Step of converting moisture contained in cyclic ester into free carboxylic acid” at the temperature condition.

A storage tank 23 is provided downstream of the melting tank 21, held at the condition described in the above-described “Holding of cyclic ester in a molten state”, and receives the feed of the cyclic ester in a molten state so that the liquid level may fall within a predetermined range by an intermittent opening and closing action of a valve 22. The cyclic ester in a molten state fed into the storage tank 23 is stirred with a multi-stage paddle blade.

Piping 30 is provided with a pump (not shown) for conveying the cyclic ester in a molten state to a polymerization section 40 at a constant speed through a valve 31 opened. The piping 30 is also provided with a dispensing part 32 of the cyclic ester in a molten state, a feed part 33 of a proton-source compound, and a charging part 34 of a catalyst which is an initiator of the ring-opening polymerization of the cyclic ester.

A quantitative measurement device 35 for measuring the amount of a free carboxylic acid contained in the cyclic ester in a molten state is provided downstream of the dispensing part 32. The quantitative measurement device 35 for free acid includes devices employing the methods as described in the above-described “Step of measuring an amount of the free carboxylic acid in cyclic ester in molten state”. A portion of the cyclic ester in a molten state will be dispensed by the dispensing part 32, and the total amount of the free carboxylic acid will be quantitatively measured by the quantitative measurement device 35.

Through the feed part 33, a proton-source compound is fed in an amount corresponding to the value obtained by subtracting an equivalent number of the free carboxylic acid measured by the quantitative measurement device 35 from the proton concentration corresponding to a desired melt viscosity (molecular weight) derived from FIG. 2. Thus, the proton concentration of the cyclic ester in a molten state is controlled to a predetermined value, and then the catalyst is charged from the charging part 34 to subject the cyclic ester to ring-opening polymerization in the polymerization section 40 to obtain an aliphatic polyester having a desired molecular weight.

The polymerization section 40 comprises a preliminary polymerizer 41 for subjecting the cyclic ester kept in the molten state to ring-opening polymerization so that the conversion may fall within the range of 5% to 50%, preferably 10% to 40%, a main polymerizer 42 for subjecting the cyclic ester to ring-opening polymerization so that the conversion may fall within the range of 50% to 90%, preferably 60% to 87%, a solidifying and grinding apparatus 43 for cooling a highly viscous melt discharged from the main polymerizer 42 to a temperature below the melting point of the aliphatic polyester to solidify and grind the melt, a solid state polymerizer 44 for holding a solid ground product discharged from the solidifying and grinding apparatus 43 at a temperature of at most the melting point of the aliphatic polyester for a long time to increase the conversion to 98% or more, preferably 99% to 100% to reduce the amount of a residual monomer to 2% or less, preferably 1% or less. As a note, the polymerization section 40 illustrated above is only an example, and is not limited to such a form.

The solid of the aliphatic polyester discharged from the polymerization section 40 may preferably be charged into a kneading apparatus (not shown) together with additives, such as a heat stabilizer for improving heat stability, a carboxyl-group capping agent for improving moisture resistance (hydrolysis resistance), a filler for improving mechanical strength, and an additive for imparting other characteristics, melt kneaded, and pelletized.

### EXAMPLE

Hereafter, the present invention will be explained more specifically with reference to an example and a comparative example explain. Characteristic values described herein are based on those measured by the following methods except what already described.

### <Melt Viscosity>

Measured by using “Semi-Auto capillary rheometer 140SAS2002” (made by YASUDA SEIKI SEISAKUSHO, LTD.) equipped with a capillary tube (1 mm-dia.×10 mmL). A sample was introduced into the apparatus heated at 240° C. held therein for 240 seconds, and then subjected to measurement at a melt viscosity (unit:Pa·s) at a shear rate of 121 sec⁻¹.

### <A Quantitative Measurement of the Free Carboxylic Acid in Glycolide>

### (1) The Neutralization Titrating Method

About 5 g of glycolide was weighed precisely and dissolved in mixture of 25 mL of acetone and 25 mL of methanol to form a sample solution. The sample solution was titrated by using as neutralization liquid a methanol solution containing sodium methoxide to detect a point of neutralization. The amount of the free carboxylic acid was calculated in terms of an equivalent number of per 1-ton of glycolide (unit:eq/t) from the detected neutralization point.

### (2) The GC Method

The content of the monomer and dimer of glycolic acid in glycolide was measured, and the OH amount was calculated. About 1 g of each sample was weighed precisely, 4-chloro benzophenone (made by Kanto Kagaku) as an internal standard substance was added and dissolved together in 5mL of acetone to form a solution sample. To 1 mL of the sample solution, diazomethane was added to methylate the glycolic acid monomer and dimer. After filtering, 1 μL of the sample solution was taken and injected to a gas-chromatograph to measure the methyl esterified glycolic acid monomer and dimer. The equivalent number (unit eq/t) of the free carboxylic acid was calculated from the measurement result.

### <GC Measurement Conditions>

Apparatus: “GC-2010” made by Shimadzu Corporation

Column: capillary column TC-17 , 30m×0.25 mm

Column temperatures: set at 50° C. for 5 min hold, heated at 20° C./min up to 270° C. and held at 270° C. for 3 min.

Injection temperature: 280° C.

Detector: FID (Flame Ionization Detector), temperature: 300° C.

### (3) The UV-VIS (Ultraviolet Visible Absorption) Spectroscopy

About 3.8 g of glycolide was weighed precisely, and dissolved in 25 mL of dimethyl sulfoxide (DMSO), followed by addition of 0.1 wt % of bromothymol blue sodium liquid to prepare a sample solution. The sample solution was placed in a quartz cell having a light path length of 10 mm to effect spectrometry in a range of 800 nm-300 nm. Absorbances at 412 nm and 636 nm were read from the spectrometry result, and a ratio (Abs412/Abs636) between the absorbance was calculated. The amount of the free carboxylic acid was calculated in terms of an equivalent number per 1-ton of glycolide (unit: eq/t) with reference to a calibration curve as shown in FIG. 5 prepared in advance.

FIG. 5 shows a calibration curve for the UV-VIS method.

### <Preparation of a Calibration Curve (FIG. 5)>

Glycolic acid was used as a standard substance to produce DMSO solutions of 0.1 eq/t, 1 eq/t, 3 eq/t, and 5 eq/t, as reference solutions. About 3800 mg of each reference solution was weighed precisely and subjected to the spectrometry according to the above-mentioned UV-VIS method procedure thereby reading the absorbencies at 412 nm and 636 nm, from which the ratio of Abs412/Abs633 was calculated. A calibration curve was prepared based on the ratios Abs412/Abs636 measured by using the reference solutions.

### <Study on the Time for Holding Molten Glycolide>

The duration of maintaining the heated state required to convert moisture contained in glycolide into a free carboxylic acid was studied.

Three initial moisture-containing samples were each prepared by adding 100 mg of water to 100 g of powdered glycolide in a glove box filled with nitrogen. These samples were heated to a temperature of 100° C., 120° C. and 140° C., respectively, and measured with respect to changes in amount of free carboxylic acid with time.

Table 1 shows the equivalent number of the free carboxylic acid present per 1 t of glycolide (unit: eq/t) with time and the increment thereof (Δeq/t) from the initial values.

FIG. 3 shows plots of the increments (Δeq/t) with time.

TABLE 1

| | | | |
|---|---|---|---|
| Time | 100° C. | 120° C. | 140° C. |

| [min.] | eq/t | Δeq/t | eq/t | Δeq/t | eq/t | Δeq/t |
|---|---|---|---|---|---|---|
| 0 | 1.0 | 0.0 | 1.1 | 0.0 | 1.0 | 0.0 |
| 60 | 3.0 | 2.0 | 3.6 | 2.5 | 4.3 | 3.3 |
| 120 | 3.9 | 2.9 | 4.4 | 3.3 | 6.1 | 5.1 |
| 240 | 4.6 | 3.6 | 5.1 | 4.0 | 6.9 | 5.9 |

The results in Table 1 and FIG. 3 reveal that the measured amounts of free carboxylic acid greatly increased until lapse of 120 minutes but hardly increased (less than 1 eq/t) after lapse of 120 minutes at any temperature of 100° C., 120° C., and 140° C. For this reason, it is believed possible to conclude that almost all moisture in glycolide has been converted into the free carboxylic acid by maintaining the heated state for 2 hours or more.

Incidentally, if 100 mg (100 mg/18=5.556 mmol) of the added water was all converted into the free carboxylic acid in 100 g of glycolide, the resulting equivalent number would have been 55.56 eq/t. However, the results in Table 1 show a value of about 10% of the equivalent number. This is probably because most of the water added to the powdered glycolide volatilized out of the system in the process of heating and melting.

Volatilization of moisture (water) from the powdered glycolide in the process of heating and melting thus reduces the free carboxylic acid to be produced. As a result, the amount of carboxylic acid in the polyglycolic acid obtained by polymerization will decrease, and the hydrolysis rate of the polyglycolic acid will be reduced.

Further, the free carboxylic acid contained in the molten glycolide increased with the increase in set temperature. This is probably because the conversion rate of moisture to the free carboxylic acid was higher than the volatilization rate of moisture at a higher temperature,

The temperature of the melting tank 21 is therefore set in the range of 85° C. to 160° C., preferably in the range of 90° C. to 120° C. in order to melt glycolide while increasing the amount of moisture volatilized and suppressing the conversion thereof into the free carboxylic acid.

### <Influence of the Holding Temperature of Molten Glycolide>

A suitable holding condition under which the concentration of the free carboxylic acid in glycolide is not varied when the glycolide is held in a molten state was studied.

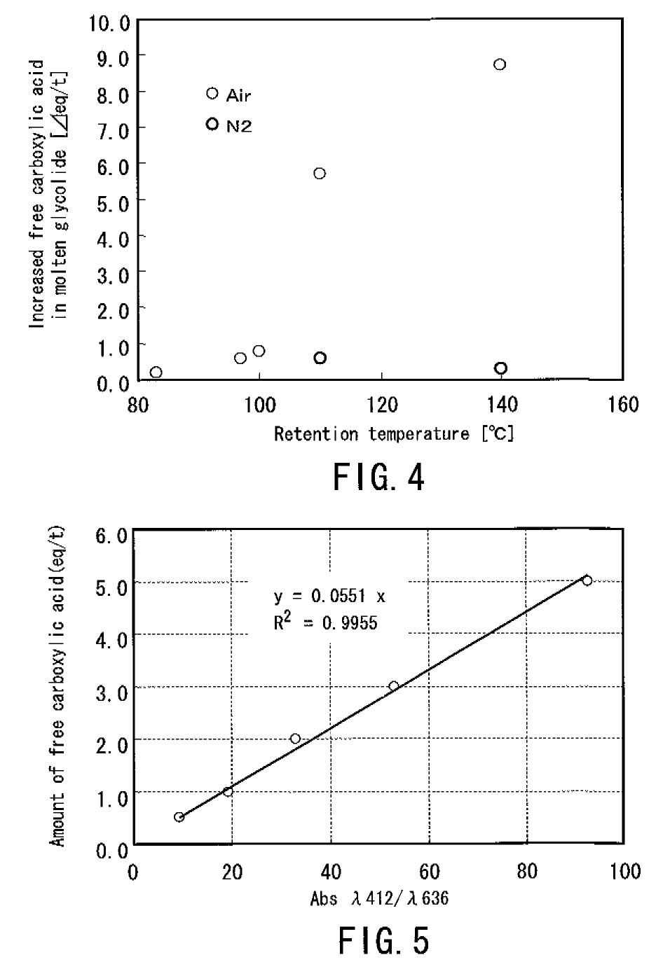

Powdered glycolide in an amount of 100 g each was placed in a glove box filled with nitrogen or dry air (having a dew point of −40° C. or less) for preparing several initial samples. These samples were heated to temperatures of 85° C., 97° C., 100° C., 110° C. and 140° C., respectively. Portions of each sample were taken at the initial point (at the lapse of 0 minute) and at the lapse of 240 minute to quantitatively measure the free carboxylic acid. Table 2 shows the equivalent number of the free carboxylic acid present per 1 t of glycolide (unit: eq/t) at the initial point (at the lapse of 0 minute) and at the lapse of 240 minutes, and the increment thereof (Δeq/t). FIG. 4 shows plots of the increment (Δeq/t) for respective conditions of temperature and atmosphere.

TABLE 2

| | | Initial value | After lapse of | |
|---|---|---|---|---|
| Atmosphere | Temperature | (at 0 min.) | 240 min. | Increment |
| in grove box | [° C.] | [eq/t] | [eq/t] | [ [symbol] eq/t] |
| Dry air | 83 | 2.6 | 2.8 | 0.2 |
| | 97 | 1.6 | 2.2 | 0.6 |
| | 100 | 2.6 | 3.4 | 0.8 |
| | 110 | 2.8 | 8.5 | 5.7 |
| | 140 | 1.0 | 9.7 | 8.7 |
| N₂ | 110 | 2.5 | 3.1 | 0.6 |
| | 140 | 1.0 | 1.3 | 0.3 |

The results in tablet above show that, in glycolide, the free carboxylic acid did not increase with increase in the setting temperature in a nitrogen environment, but the free carboxylic acid increased at 110° C. or higher in dry air atmosphere. On the other hand, the increase in free carboxylic acid at 100° C. or lower in dry air atmosphere was suppressed to 1.0 eq/t at the maximum. Therefore, when the molten glycolide is stored in an atmosphere containing air or oxygen in the storage tank 23, the temperature is preferably set at 85° C. (melting point of GL) or higher and below 110° C. Further, the holding of the molten glycolide in an oxygen-containing atmosphere for more than 2 hours at a temperature of 110° C. or higher, preferably be avoided.

### <Production Conditions>

The production apparatus shown in FIG. 1 was used. As for the production conditions, powdery glycolide was accommodated in the melting tank 21 set at a temperature in a range of 95 to 105° C. to be melted and then stored for 3 hours. Subsequently, the valve 22 was opened to charge the molten glycolide into the storage tank 23 having a temperature set at 95 to 105° C. The feed rate of the molten glycolide from the storage tank 23 to the preliminary polymerizer 41 was set at 30 kg/hr.

Lauryl alcohol was continuously fed through the feed part 33 so that the sum of the total proton concentration of the polymerization system would be 0.28 mol % (a target melt viscosity of 850 Pa·s (240° C.), refer to FIG. 2) as a targeted value. The feed rate of lauryl alcohol was an amount corresponding to the value obtained by subtracting the result of quantitative measurement of the free carboxylic acid (concentration of protons in the cyclic ester) from the targeted value (0.28 mol %).

Then, an ethyl acetate solution of tin dichloride (catalyst) (having a concentration of 0.015 g/ mol) was continuously charged through the charging part 34, wherein the concentration of tin dichloride calculated as tin dioxide was set so that it would be 30 wt. ppm relative to glycolide.

The preliminary polymerizer 41 was a vertical cylindrical liquid-filled type polymerizer having an internal volume of 1.8 L in which the molten glycolide fed from the bottom was stirred with a twin-shaft multi-stage paddle blade, and it was set at a temperature of 180° C. The main polymerizer 42 was of a horizontal equi-directionally rotating twin-screw type, and it was set at a temperature of 200° C. to 210° C.

The solidifying and crushing apparatus 43 was also of a horizontal equi-directionally rotating twin-screw type, and it was set at a temperature of 80° C. The solid-state polymerizer 44 was a reversed conical shape polymerizer having an inner capacity of 1 m³ and was equipped with a planetary screw stirrer, in which the temperature was controllable. The crushed reaction product from the solidifying and crushing apparatus 43 was accumulated to about 480 kg and subjected to solid-state polymerization at 170° C. for 2 hours. The resulting polyglycolic acid resin was crushed to a particle size of 6 mm or less and obtained as about 470 kg of the resin.

### <A Method of Calculating Proton Concentration>

The proton concentration in glycolide is calculated as follows from the concentration of free carboxylic acid or the measured amounts of glycolic acid monomer and a glycolic acid dimer.

[Calculation from Concentration of Free Carboxylic Acid]

(concentration of free carboxylic acid (eq/t))×116.072/10000=(proton concentration in glycolide (mol %)).

[Calculation from the Measured Amounts of Glycolic Acid Monomer and Dimer]

((amount of glycolic acid monomer (wt %)/76.051)+(amount of glycolic acid dimer (wt %) / 134.09))×116.072/10000=(proton concentration in glycolide (mol %)).

### <A Calculation for Determining Amount of Lauryl Alcohol to be Supplied>

Based on the required increase of proton concentration (mol %) due to addition of lauryl alcohol calculated in the above-described manner, the rate of the lauryl alcohol to be supplied in a polymerization system is calculated as follows.

(The amount of lauryl alcohol to be supplied (kg/hr))=(glycolide amount of supply (kg/hr))/116.072×(the increase of proton concentration due to addition of lauryl alcohol)×186.34/100.

### <Implementation of Actual Production>

Based on the above-described production conditions, trial production of polyglycolic acid using glycolide as a raw material was performed.

Examples 1 to 5 in Table 3 show the results of the quantitative analysis of the free carboxylic acid in the molten glycolide sampled from the dispensing part 32, the concentration of protons in the glycolide calculated from the analysis results, the concentration of alcohol fed from the feed part 33 which was set based on the results of quantitative measurement, and the total concentration of protons in the polymerization system. Here, any one of a neutralization titration method (*1), a GC method (*2), and a UV-VIS method (*3) was employed as the method for quantitatively measuring the free carboxylic acid in each Example. Note that in the GC method, the measurement was separately applied to the monomer and the dimer, respectively, of glycolic acid, but the monomer was not detected. Further, the measured values of the melt viscosity of the resulting polyglycolic acid resin are shown for Examples 1 to 5.

In addition, the powdery glycolide before being accommodated in the melting tank 21 was sampled and subjected to the quantitative analysis of the free carboxylic acid in the same manner, as shown in Comparative Examples 1 and 2. Then, the concentration of protons in glycolide was calculated based on the analysis results, and the concentration of alcohol to be fed was set based on the results to perform trial production. Each condition and the resulting melt viscosity of polyglycolic acid resin are also collectively shown in Table 3.

Further, the melting temperature of glycolide in the melting tank 21 was set at 120C, and the holding temperature of the storage tank 23 was also set at 120C. The results in this case, obtained in the same manner, are shown in Table 3 as Comparative Example 3. Note that the quantitative measurement of the free carboxylic acid in Comparative Example was performed for the molten glycolide dispensed from the valve 22 (employing experimental data obtained before implementing the present invention).

TABLE 3

| | | | | Proton | | |
|---|---|---|---|---|---|---|
| | | Free | Proton | concentration | Total | |
| | | carboxylic | concentration | of lauryl | proton | Melt |
| | State of | acid | in glycolide | alcohol | concentration | viscosity |
| | glycolide | [eq/t] | [mol %] | [mol %] | [mol %] | [Pa · s] |
| Example 1 | Molten | 1.1*¹ | 0.01 | 0.27 | 0.28 | 880 |
| Example 2 | Molten | 5.8*¹ | 0.07 | 0.22 | 0.28 | 879 |
| Example 3 | Molten | 1.0*² | 0.01 | 0.27 | 0.28 | 812 |
| Example 4 | Molten | 0.9*¹ | 0.01 | 0.27 | 0.28 | 835 |
| Example 5 | Molten | 0.6*³ | 0.01 | 0.27 | 0.28 | 834 |
| Comparative 1 | Powder | 0.7*¹ | 0.01 | 0.27 | 0.28 | 702 |
| Comparative 2 | Powder | 1.4*² | 0.02 | 0.23 | 0.25 | 660 |
| Comparative 3 | Molten | 3.0*² | 0.03 | 0.25 | 0.28 | 640 |

*¹Neutralization titration method
*²GC method
*³UV-VIS method

The results of Examples and Comparative Examples 1 and 2 are studied.

The melt viscosities in Examples 1 to 5 are in the range of deviation about 5% at the maximum relative to the targeted value of about 850 Pa·s.

The melt viscosity in Comparative Example 1 was 702 Pa·s (deviation of 18%) relative to the targeted value of about 850 Pa·s.

The melt viscosity in Comparative Example 2 was 660 Pa·s (deviation of −40%) relative to the targeted value of 1130 Pa·s since the total proton concentration was 0.25 mol % (refer to FIG. 2).

From these results, it has been verified that it is possible to accurately estimate the concentration of protons in the system and set the molecular weight of polyglycol with high accuracy by holding a molten glycolide for a predetermined period of time to convert moisture contained into a free carboxylic acid and then performing the quantitative measurement of the free carboxylic acid of the whole system.

The results of Examples and Comparative Example 3 are studied.

The melt viscosity in Comparative Example 3 was 640 Pa·s (deviation of 26%) relative to the targeted value of about 850 Pa·s.

This is probably because, in Comparative Example 3, since the molten glycolide was stored at a high holding temperature in a dry air atmosphere, the amount of the free carboxylic acid was increased in the storage tank 23 to a higher value than the value shown in Table 2.

Five batches of operation were performed successively to evaluate the production stability according to the same production conditions and quantitative measurement conditions, respectively, as in Example 1, and the results thereof are shown in Table 4. As a result, the melt viscosity at 240° C. resulted in an average value of 834 Pa·s and a standard deviation of 22 Pa·s.

TABLE 4

| | | | | Proton | | |
|---|---|---|---|---|---|---|
| | | Quantitative | | concentration | | |
| | | estimation | | of | Total | |
| | | Free acid | Proton | lauryl | proton | Melt |
| | States of | (titration) | concentration | alcohol | concentration | viscosity |
| | glycolide | [eq/t] | [mol %] | [mol %] | [mol %] | [Pa · s] |
| Example 6 | Molten | 0.6 | 0.01 | 0.27 | 0.28 | 843 |
| Example 7 | Molten | 1.2 | 0.01 | 0.26 | 0.28 | 809 |
| Example 8 | Molten | 2.0 | 0.02 | 0.25 | 0.28 | 837 |
| Example 9 | Molten | 1.6 | 0.02 | 0.26 | 0.28 | 865 |
| Example 10 | Molten | 1.0 | 0.01 | 0.27 | 0.28 | 816 |
| | | | | | Average | 834 |
| | | | | | Standard | 22 |
| | | | | | deviation | |

What is claimed is:

1. A process for producing an aliphatic polyester, comprising the steps of:
heating a cyclic ester at a melting point or higher to transform the cyclic ester into molten state and convert a moisture contained in the cyclic ester into free carboxylic acid;
measuring an amount of the free carboxylic acid in the molten cyclic ester;
feeding a proton-source compound in an amount determined based on the measured amount of the free carboxylic acid into the molten cyclic ester; and
subjecting the cyclic ester to ring-opening polymerization.

2. A production process according to claim 1, wherein the step of converting the moisture into the free carboxylic acid is operated by maintaining the temperature of the cyclic ester set at a melting point or higher for 1 hour or more.

3. A production process according to claim 1, wherein the step of converting the moisture into the free carboxylic acid is operated by maintaining the temperature of the cyclic ester set at a melting point or higher for 2 hour or more.

4. A production process according to claim 1, wherein the step of converting the moisture into the free carboxylic acid is operated in a temperature range of 85° C.-160° C.

5. A production process according to claim 1, further comprising a step of: holding the molten cyclic ester at temperature range of 85° C.-110° C. after the step of the converting the moisture into the free carboxylic acid.

6. A production process according to claim 1, wherein the step of measuring the amount of the free carboxylic acid in the molten cyclic ester is performed by using any one of a neutralization titration method, a gas chromatography method, and an UV-VIS spectrometry.

7. A production process according to claim 1, wherein the cyclic ester is glycolide, lactide, or a mixture thereof.

8. A production process according to claim 1, wherein the proton-source compound is selected from the group of medium to higher alcohols alicyclic alcohols, diols, and triols each three or more carbon atoms.

9. A apparatus for producing an aliphatic polyester, comprising:
a melting tank for heating a cyclic ester at a melting point or higher to transform the cyclic ester into molten state and convert a moisture contained in the cyclic ester into a free carboxylic acid;
a dispensing part for sampling the molten cyclic ester for measuring an amount of the free carboxylic acid;
a feed part for feeding the proton-source compound in an amount determined based on the measured amount of the free carboxylic acid into the molten cyclic ester; and
a polymerization section for subjecting the cyclic ester to ring-opening polymerization.
